(19) United States
(12) Patent Application Publication
(10) Pub. No.: US 2015/0127246 A1
(43) Pub. Date: May 7, 2015

(54) METHOD AND SYSTEM FOR DETECTING STATE OF A TWO-WHEEL BALANCE VEHICLE

(71) Applicant: INMOTION Technologies Co., Ltd., Shenzhen (CN)

(72) Inventor: Gavin GUO, Shenzhen (CN)

(73) Assignee: INMOTION Technologies Co., Ltd., Shenzhen (CN)

(21) Appl. No.: 14/103,869

(22) Filed: Dec. 12, 2013

(30) Foreign Application Priority Data
Nov. 1, 2013 (CN) 201310529383.7

(51) Int. Cl. B62K 3/00

(52) U.S. Cl. CPC B62K 3/007
USPC 701/124

(57) ABSTRACT

A method and a system for detecting the state of a two-wheel balance vehicle are provided. The method comprises the following steps: S1, detecting pressure output by pedals of the two-wheel balance vehicle in real time after starting; S2, judging if the pressure increases; S3, if the pressure increase is greater than a predetermined half-load threshold value, switching into half-loaded state; and if the pressure increase is greater than a predetermined full-load threshold value, switching into fully-loaded state. Through the method and the system, getting on and off the vehicle becomes more convenient, effectively improving safety for drivers.

### BACKGROUND OF THE INVENTION

The present invention relates to a two-wheel balance vehicle, in particular to a method for detecting state of a two-wheel balance vehicle.

Various types of two-wheel balance vehicles are currently available on the market. All those two-wheel balance vehicles currently detect whether drivers get on through switch sensors such as photoelectric switches and or mechanical switches. Those sensors feature in that they can only obtain switch quantity, meaning existence of a driver or inexistence of a driver and cannot obtain pressure on pedals.

Due to a particularity of two-wheel balance vehicles, new drivers have some problems during learning. For example, when getting on a vehicle, the new driver has one foot on the vehicle and the other on the ground. Only a small part of weight of the driver is put on the vehicle, and the foot on the ground bears the majority of weight. In such circumstances, new drivers easily rock the vehicle, causing discomfort or safety problems. When getting off the vehicle, the new driver also has one foot on the vehicle and the other on the ground. The new driver usually fails to move the foot on vehicle to the ground and pulls the rod back at the same time for fear or other reasons, so the balance vehicle runs over the foot and causes injury human body.

### BRIEF SUMMARY OF THE INVENTION

The technical problem to be solved by the present invention is to provide a method and a system for detecting state of a two-wheel balance vehicle, realizing control over load state through change amount of pressure on pedals and effectively improving safety for drivers.

To solve the mentioned technical problem, on one hand, the present invention provides a method for detecting state of a two-wheel balance vehicle, comprising the following steps.

A method for detecting state of a two-wheel balance vehicle, comprising the following steps:

S1, detecting pressure output by pedals of the two-wheel balance vehicle in real time after starting;

S2, judging if the pressure increases;

S4, if the pressure increase is greater than a predetermined half-load threshold value, switching into half-loaded state; and if the pressure increase is greater than a predetermined full-load threshold value, switching into fully-loaded state.

Between step S4 and step S2, the method also comprises a step S3; if the pressure increase is greater than the half-load threshold value, recording the pressure value at the previous moment of the pressure increase, and setting this pressure value as zero point of pressure.

The method also comprises steps:

S5, after switching into the fully-loaded state, calculating difference between current pressure output by pedals and pressure at the zero point;

S6, if the difference between current pressure output by pedals and pressure at the zero point is smaller than the full-load threshold value and greater than the half-load threshold value, switching from the fully-loaded state into the half-loaded state; and if the difference between current pressure output by pedals and pressure at the zero point is smaller than the half-load threshold value, switching from the fully-loaded state into empty-loaded state.

On the other hand, the present invention also provides a system for detecting state of a two-wheel balance vehicle. The system comprises a detecting unit for detecting pressure output by pedals of the two-wheel balance vehicle in real time; a judging unit for detecting pressure increase; and a comparing unit for comparing the pressure increase with the predetermined half-load threshold values and full-load threshold values.

The system also comprises a recording unit for recording pressure value at the previous moment of the current pressure increase when the pressure increase is greater than the half-load threshold value after starting; and a record setting unit for setting zero point of pressure.

The system also comprises a calculating unit for calculating difference between the current pressure output by pedals and the pressure at the zero point.

Through change in output of pressure on pedals, the present invention adopts dynamic zero point of pressure to realize control over load slate, such as half-loaded, fully-loaded and empty-loaded states, thus driving the control system to limit output power and effectively improving safety of drivers.

### BRIEF DESCRIPTION OF THE DRAWINGS

FIG. 1 is a flowchart of method of the present invention starting and entering the load state;

FIG. 2 is a flowchart of method of the present invention switching from fully-loaded state into half-loaded or empty-loaded state;

FIG. 3 is a schematic view of the system of the present invention.

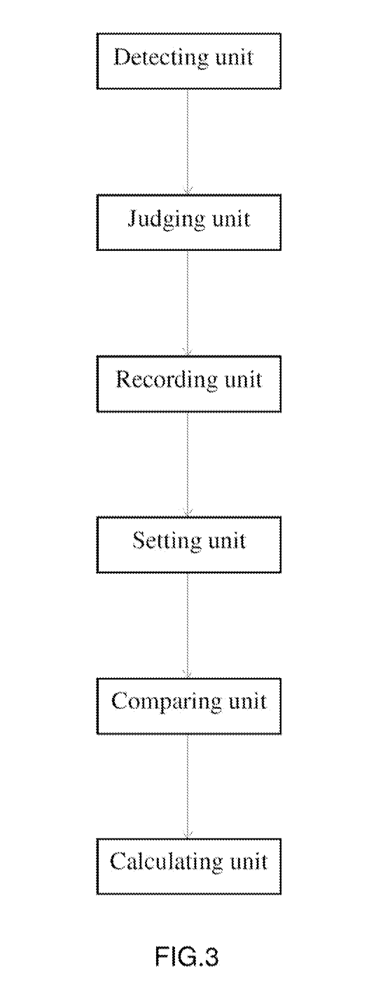

### DETAILED DESCRIPTION OF THE INVENTION

To be better understood by those skilled in the art, the present invention is described in further detail with reference to the attached drawings.

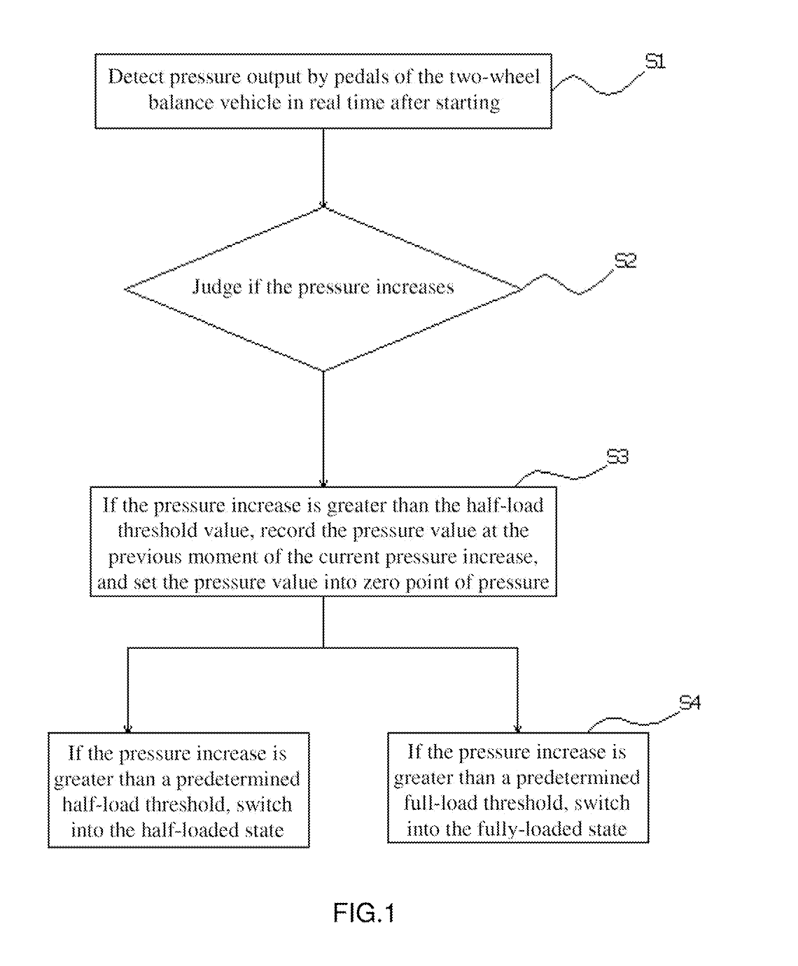

The present invention discloses a method for detecting state of a two-wheel balance vehicle, as shown in FIG. 1, comprising the following steps;

S1, Detecting pressure output by pedals of the two-wheel balance vehicle in real time after starting. The two-wheel balance vehicle starts to detect pressure output by pedals, namely value of pressure on pedals, after being started.

S2, Judging if the pressure increases. From the moment of starting, the two-wheel vehicle judges if the output pressure changes positively, namely increases, according to the pressure output by pedals. If the pressure value of the previous moment is 100, and the pressure value of the next moment is 120, then the pressure increases; and if the pressure value of the next moment is 80 then the pressure decreases.

S4, If the pressure increase is greater than a predetermined half-load threshold value, switching into the half-loaded state; and if the pressure increase is greater than a predetermined full-load threshold value, switching into the fully-loaded state. Judged in step S2, if the pressure does not increase or decrease then return to step S1 for detection continuously. Only both conditions that the pressure increases and that the pressure increase is greater than a predetermined half-load threshold value or a predetermined fully-loaded value are met at the same can the two-wheel vehicle be switched into the half-loaded state or fully-loaded state. As long as the two-wheel vehicle fails to meet either condition, it fails to enter the corresponding loaded state, but keeps the current loaded state.

For further control, between step S2 and step S4, the method also comprises step S3: if the pressure increase is greater than the half-load threshold value, recording the pressure value at the previous moment of the current pressure increase and setting this pressure value as zero point of pressure. From starting, the change amount of the detected real-time pressure output by pedals is compared with a predetermined half-load threshold value as the pressure changes; when the difference in mounts of pressure change of previous and next moment is greater than the half-load threshold value and the pressure value at the next movement is greater than that at the previous moment, the pressure value at the previous moment of the current pressure change is set into zero point; if the difference in amounts of pressure change of previous and next moment is smaller than the half-load threshold value, recording is not implemented, and the pressure value at the previous moment of the current pressure change is not set into zero point. This means that the zero point is not predetermined, but dynamic, and that the pressure at zero point is not that at the moment of starting, but variable.

After the zero point is set, in step S4, if the pressure increase is greater than the predetermined half-load threshold value, the two-wheel balance vehicle enters the half-loaded state; if the pressure increase is greater than the predetermined fully-loaded threshold value, the two-wheel balance vehicle enters the fully-loaded state. The pressure increases are obtained through comparing with the pressure of the zero point, meaning that only when the difference between the pressure at the current moment and the pressure at the zero point is greater than the half-load threshold value or the full-load threshold value can the two-wheel balance vehicle enters the corresponding half-loaded or fully-loaded state. This means that the mount of the pressure change is obtained through comparing with the pressure corresponding to the zero point after the zero point is set.

The above description can be regarded as the whole process that the driver gets on the vehicle after the two-wheel balance vehicle is started, meaning that the vehicle is switched from the empty-loaded state into the fully-loaded state.

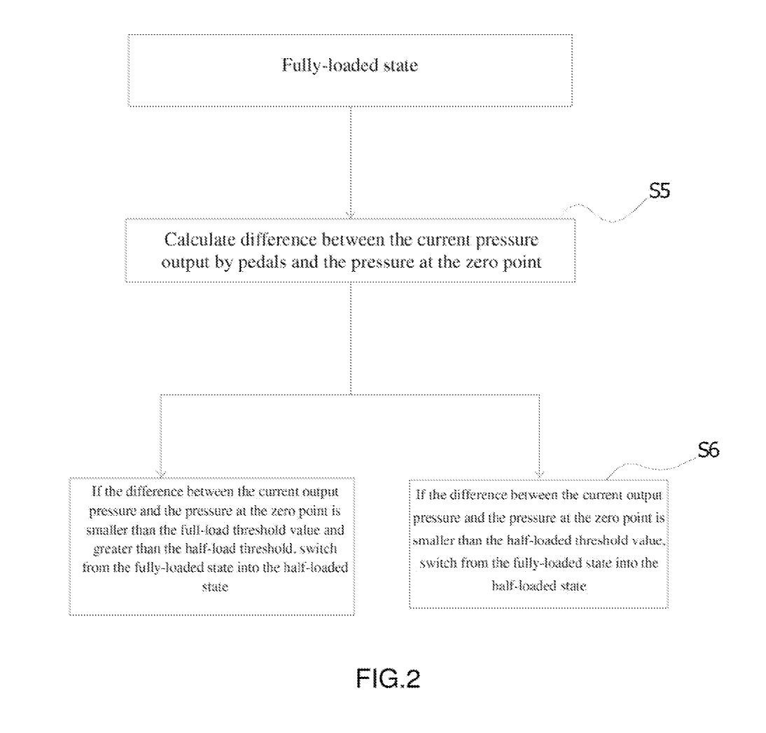

To further ensure stability and improve safely, as shown in FIG. 2, the method also comprises steps:

S4, calculating difference between current pressure output by pedals and pressure at the zero point after the vehicle enters the fully-loaded state, the zero point being the zero point set in step S3;

S5, if the difference between the current pressure output by pedals and the pressure at the zero point is smaller than the full-load threshold value and greater than the half-load threshold value, switching from the fully-loaded state into the half-loaded state; and if the difference between current pressure output by pedals and the pressure at the zero point is smaller than the half-load threshold value, switching from the fully-loaded state into the empty-loaded state.

The above-mentioned half-loaded state refers to that the driver outputs a minority of the weight on the vehicle body, and the majority on the ground. The fully-loaded state refers to that the driver puts on all the weight on the vehicle body. Empty-loaded state refers to that the drivers entire weight is not on the vehicle body, meaning that the vehicle body does not detect extra pressure. The weight can be converted into pressure and predetermined flexibly according to actual situation.

The state of the two-wheel balance vehicle is controlled through the above dynamic zero point setting. After the vehicle is switched from the empty-loaded state into the half-loaded state, corresponding control system limits the output power of the whole vehicle such that the vehicle speed is limited, thus reducing injury in accidents. After the vehicle enters the fully-loaded state, the output power is not limited, and the sensitivity of the control system is recovered, so full-power output is allowed to ensure safety.

After the vehicle is switched from the fully-loaded state into the half-loaded state, this shows that the driver may get off the vehicle. At this moment, the control system is limited in power output and then stops working, thus avoiding the situation that the vehicle moves back and runs over the food when the driver places one foot on the vehicle and the other on the ground, and effectively improving safe for new drivers.

Moreover information about the driver such as weight and change of the weight can be obtained through the pressure, and displayed through the display on the vehicle to remind the driver. It is more humanized and intellectualized.

It should be noted that the description above cannot be regarded as limit of the present invention. Without departing from the inventive concept of the present invention, any substitution falls within the protective scope of the present invention.

What is claimed is:

1. A method for detecting the state of a t heel balance vehicle, comprising the following steps:
S1, detecting pressure output by pedals of the two-wheel balance vehicle in real time after starting;
S2, judging if the pressure increases;
S4, if the pressure increase is greater than a predetermined half-load threshold value, switching into a half-loaded state; and if the pressure increase is greater than a predetermined full-load threshold value, switching into fully-loaded state.

2. The method for detecting the state of a two-wheel balance vehicle according to claim 1, between step S4 and step S2, also comprising step S3: if the pressure increase is greater than a half-load threshold value, recording the pressure value at the previous moment of current pressure change, and setting the pressure value as zero point of pressure.

3. The method for detecting state of a two-wheel balance vehicle according to claim 2, said method also comprising steps:
S5, calculating difference between the current pressure output by pedals and pressure at the zero point in real time after switching into the fully-loaded state;
S6, if the difference between the current output pressure and the pressure at the zero point is smaller than a full-load threshold value and greater than a half-loaded threshold value, switching from the fully-loaded state into the half-loaded state; and if the difference between the current output pressure and pressure at zero point is smaller than the half-load threshold value, switching from the fully-loaded state into the empty-loaded state.

4. A system for detecting the state of a two-wheel balance vehicle, said system comprising a detecting unit for detecting pressure output by pedals of the two-wheel balance vehicle in real time;
a judging unit for judging change of pressure;
a comparing unit for comparing change amount of the pressure with a predetermined half-load threshold value and a full-load threshold value.

5. The system for detecting the state of a two-wheel balance vehicle according to claim 4, said system also comprising a recording unit for recording the pressure value at the previous moment of the current pressure change when the pressure increase is greater than the half-load threshold value after starting; and a setting unit for setting zero point of pressure.

6. The system for detecting the state of a two-vehicle balance vehicle according to claim 5, said system also comprising a calculating unit for calculating difference between the current pressure output by pedals and the pressure at the zero point.
